(19) United States
(12) Patent Application Publication
(10) Pub. No.: US 2026/0210171 A1
(43) Pub. Date: Jul. 23, 2026

(54) PARALLEL HERMETIC SEALS AND ASSEMBLY INCLUDING THE SAME

(71) Applicant: V-GLASS, INC., Pewaukee, WI (US)

(72) Inventor: Peter Petit, Pewaukee, WI (US)

(21) Appl. No.: 19/139,665

(22) PCT Filed: Oct. 13, 2023
(86) PCT No.: PCT/US2023/035155

§ 371 Date: Jun. 16, 2025

Related U.S. Application Data
(60) Provisional application No. 63/387,470, filed on Dec. 14, 2022.

(51) Int. Cl. E06B 3/66; E06B 3/663; E06B 3/673

(52) U.S. Cl. CPC E06B 3/6612; E06B 3/66304; E06B 3/67326

(57) ABSTRACT

An evacuated glazing assembly having first and second spaced-apart substrates connected to each other by a seal element to form an evaluable interior space therebetween. The seal element is formed by bonding a metallic bridge element to at least one of the substrates with a cold weld. The cold weld includes at least two spaced-apart, highly-hermetic seal elements fabricated simultaneously during bonding on the at least one of the substrates.

### CROSS-REFERENCE TO RELATED APPLICATIONS

The application is a national stage entry of PCT Application No. PCT/US2023/035155, filed Oct. 13, 2023, which claims priority to U.S. Provisional Patent Application No. 63/387,470, filed Dec. 14, 2022, the entire content of each of which is incorporated herein by reference.

### STATEMENT REGARDING FEDERALLY-SPONSORED RESEARCH OR DEVELOPMENT

This invention was made with government support under SBIR Assistance Agreement DE-SC0017841 awarded by the United States Department of Energy. The government has certain rights in the invention.

### FIELD OF THE INVENTION

The present invention relates to a process for creating a hermetic seal including of multiple parallel seals for an envelope having an interior region that is isolated from the environment.

### BACKGROUND

Many existing evacuated glazing assemblies (e.g., vacuum-insulated glass (“VIG”) assemblies) include two or more panes (e.g., glass panes) that are separated from each other by a space. A temperature differential across the assembly can significantly impact the structure of the assembly and, in some cases, cause the assembly to fail. For example, when an evacuated glazing assembly is installed in an exterior wall of a temperature-controlled and/or insulated building, the temperature of the exterior pane typically approaches the outside air temperature (contracting when exposed to cold, expanding when exposed to heat). The interior pane typically remains at a relatively constant temperature that is consistent with the inside air temperature. Movement of the exterior pane (i.e., contraction or expansion) relative to the interior pane is known as “differential pane movement.” For a VIG made using a rigid edge seal material such as solder glass, differential pane movement will cause result in increased stress in the seal material. Excessive differential pane movement will cause the rigid seal to lose hermeticity, e.g., by cracking, or by partially delaminating from the glass panes, thereby degrading the ability of the VIG to insulate due to loss of vacuum.

The most widely-used existing evacuated glazing unit designs use a seal element incorporating solderglass to connect unmetallized glass panel edges (e.g., Collins, U.S. Pat. No. 5,657,607). More recent evacuated glazing unit designs use a seal element incorporating brazed metal to connect metallized glass panel edges (e.g., Li, U.S. Pat. No. 8,899,472; Caliaro, WO2017174349A1). Both of these design approaches require the use of ovens to melt the seal materials, which require a heating/cooling cycle that typically takes hours. The long cycle time for oven-based processes is a virtually insurmountable barrier to low manufacturing cost.

Other existing evacuated glazing units use a seal element that incorporates oven-free metallization of glass panel edges. The metallization is accomplished using a physical vapor deposition (PVD) or chemical vapor deposition (CVD) process. Such metallization processes require the use of a vacuum chambers to form a metal adhesive layer that is incorporated into an oven-free seal element such as low-temperature solder (e.g., Bächli, U.S. Pat. No. 5,227,206) or ultrasonic welding of metal foil (e.g., Friedl, US20080245011). The large capital and operating cost required by a vacuum chamber-based process, in addition the complexities inherent in the process, is a virtually insurmountable barrier to low manufacturing cost.

### SUMMARY

One type of hermetic seal element that may be used to seal between panes of an evacuated glazing assembly includes a metallic bridge element (e.g., a metal foil) that is ultrasonically-welded to a metallic adhesive layer deposited on the panes.

A process for metallizing a non-metallic substrate (e.g., glass) that is done without an oven and without a vacuum chamber can be used to create a hermetic or non-hermetic seal element for an envelope (made of glass or another non-metallic substrate) with an interior region that is isolated from the environment. The seal element is formed by a metallized layer on the substrate and a metallic bridge element that is connected to a non-metallic substrate by the metallic layer. The seal element is formed under ambient conditions and does not require an oven chamber or a vacuum chamber. The process involves subjecting the surface of a substrate to a metal deposition process which does not require an oven or a vacuum chamber to form a metallic adhesive layer that is continuous along the perimeter of the region to be isolated from the environment. A bridge element is attached or connected to the metal adhesive layer is connected to form a seal element along the perimeter of the interior region to be isolated from the environment. The invention provides a seal design that is flexible enough to accommodate differential pane movement. The flexible, hermetic seal element allows the use of tempered or annealed glass, and the use of glass panes with sputtered low-emissivity coatings without causing detriment or damage due to a seal manufacturing process requiring high temperature.

Fabricating an enclosure with an interior space that is isolated from the environment by a hermetic seal element virtually eliminates deleterious gas migration into and out of the isolated space. Large, flat, hermetically-sealed glass enclosures may be used as fog-free multi-pane argon-filled insulating glass units for windows, vacuum-insulated glazing units, flat panel displays, neutron detector panels for detecting nuclear materials, and packaging for microelectromechanical systems (“MEMS”), among other applications.

A seal element may be formed using friction surfacing that produces a metal adhesive coating on a non-metal substrate. A metal foil bridge element connects to the metal adhesive coatings on two opposed substrates using a process that does not require an oven or a vacuum chamber (e.g., low temperature solder or ultrasonic welding). Although a vacuum chamber is not required, the seal element can optionally be completed at atmospheric pressure or under vacuum conditions.

A structural element for buildings may have at least two spaced-apart non-metal substrates connected to each other by a seal element to form an evaluable gap therebetween. The seal element is formed by subjecting at least one surface of each of the non-metal substrates to an oven-free, vacuum chamber-free metal deposition process to form a metallic layer on each of the substrates. The metallic layers define coatings that are continuous along a perimeter of the evaluable gap. a metal bridge element is connected to the metallic layer to form a seal of the evaluable gap. The seal can be hermetic or non-hermetic.

A method of manufacturing a structural element including first and second substrates of substantially congruent shapes includes forming a seal element between the substrates to define an evaluable gap. The seal element is formed by the process of subjecting at least one surface of each substrate to an oven-free, vacuum chamber-free metal deposition process to form a metallic layer on the substrates. The metallic layers define coatings that are continuous along the perimeter of the evaluable gap. A bridge element is connected to the metallic layers to define a hermetic or non-hermetic seal of the evaluable gap.

An insulated glazing unit may include a first flat panel element, a second flat panel element, and a plurality of spacers disposed between the first flat panel element and the second flat panel element to space the first flat panel element from the second flat panel element. The unit also includes a seal element that connects the first flat panel element and the second flat panel element to form an evaluable gap therebetween. The seal element is formed by the process of subjecting at least one surface of each substrate to an oven-free, vacuum chamber-free metal deposition process to form a metallic layer on each of the substrates. The metallic layers define coatings that are continuous along a perimeter of the evaluable gap, and a bridge element is connected to the metallic layers to form a hermetic or non-hermetic seal of the evaluable gap.

A method of manufacturing a structural element including a substrate defining an interior space includes forming a seal element to enclose the interior space and define an evaluable gap. The seal element is formed by the process of subjecting a surface of the substrate to an oven-free, vacuum chamber-free metal deposition process to form a metallic layer on the substrate. The metallic layer defines a coating that is continuous along a perimeter of the interior space. A bridge element is connected to the metallic layer and extends across the interior space to define a seal of the evaluable gap.

A process for creating a seal element for incorporation into an envelope having an interior region isolated from an environment may include subjecting the surface of a wall element to a metal deposition process that is oven-free and vacuum chamber-free to form a metallic layer extending continuously along the perimeter of the interior region to be isolated from the environment, and connecting a bridge element to the metallic layer to form a seal element along the perimeter of the interior region.

A method of manufacturing a structural element includes subjecting a surface of a non-metallic substrate to an oven-free, vacuum chamber-free metal deposition process including friction surfacing to form a metallic layer on the substrate. The metallic layer defines a coating on the substrate, and a metal foil is connected to the metallic layer.

A structural element may include a non-metallic substrate that has a metallic layer on at least a portion of the substrate and that is formed using a friction surfacing process. A metal foil is attached to the substrate via the metallic layer, and the friction surfacing process includes subjecting at least one surface of the substrate to an oven-free, vacuum chamber-free metal deposition process.

A method of manufacturing a structural element includes subjecting a surface of a non-metallic substrate to an oven-free, vacuum chamber-free metal deposition process that involves friction surfacing to form a metallic layer on at least a portion of the substrate, the metallic layer defining a coating on the substrate.

Non-metallic substrates are typically brittle, and the high loads and temperatures used in traditional friction surfacing of metal substrates must be mitigated or limited to avoid fracture of the non-metallic substrate or tearing of its surface which can cause leakage. Besides not requiring an oven or a vacuum chamber, an advantage of using friction surfacing for metallizing a non-metallic substrate is that it can greatly reduce or eliminate oxides (e.g., aluminum oxide) and other reaction-inhibiting contaminants from the faying surfaces (e.g., at the glass interface with the deposited metal). Before the present invention, it was not known to use, or how to apply friction surfacing to generate a metal coating on a non-metal substrate (e.g., to form a hermetic seal).

Metallic bridge element hermetic seals may fail (that is, leak) via a variety of different mechanisms, including microleakage paths along and imperfect interface between the metallic bridge element and the glass, flaws in the metallic bridge element (e.g., scratches, wrinkles, microstructure damage, perforation through or along the edges of welds, joints between discrete segments comprising a metallic bridge element, etc.), flaws in the glass (e.g., scratches), flaws due to uncontrolled process parameter variations (e.g., due to “tramp” metal adhered to the sonotrode), and misalignment of weld segment ends where they overlap. While these failure mechanisms may be minimized using tightly-controlled manufacturing processes, a need exists for a seal configuration that can provide more reliable hermeticity in a cost-efficient manner.

The invention provides, in one aspect, an evacuated glazing assembly having first and second spaced-apart substrates connected to each other by a metallic bridge element to form an evaluable interior space therebetween. The metallic bridge element is bonded to at least one of the substrates by cold welding to effectively isolate the interior space from the surrounding environment.

The invention provides, in another aspect, an evacuated glazing assembly including a first substrate, a second substrate spaced from the first substrate to define an interior space therebetween, and a metallic bridge element disposed between the first substrate and the second substrate to isolate the interior space from a surrounding environment. The metallic bridge element includes a cold weld bond between the metallic bridge element and the first substrate, said cold weld including two or more highly-hermetic continuous parallel seals.

The invention provides, in another aspect, a method of forming a cold weld element for hermetically sealing between two substrates of an evacuated glazing assembly. The method includes bonding a metallic bridge element to each of the two substrates using a sonotrode shape that forms two or more highly-hermetic continuous parallel seals.

In an aspect, the invention includes evacuated glazing assembly having first and second spaced-apart substrates connected to each other by a seal element to form an evaluable interior space therebetween. The seal element may be formed by bonding a metallic bridge element to at least one of the substrates with a cold weld.

In another aspect, the invention includes a method of forming a metallic bridge element for hermetically sealing between two substrates of an evacuated glazing assembly. The method includes bonding a metallic bridge element to each of the two substrates to form at least two hermetic sealing stages, applying a sealing material at least partially in contact with a first hermetic sealing stage of the hermetic sealing stages, curing the sealing material to form a second hermetic sealing stage of the hermetic sealing stages.

In at least one aspect, bonding the metallic bridge element to each of the two substrates is accomplished by cold welding.

In at least one aspect, the metallic bridge element material includes at least one selected from a group consisting of aluminum, titanium and copper.

In another aspect, the invention provides a structural element for buildings having at least two spaced-apart non-metal substrates connected to each other by a seal element to form an evaluable gap therebetween. The seal element is formed by subjecting at least one surface of each of the non-metal substrates to an oven-free, vacuum chamber-free metal deposition process to form a metallic layer on each of the substrates. The metallic layer on each of the non-metal substrates may define coatings that are continuous along a perimeter of the evaluable gap. The seal element is further formed by connecting a metal bridge element to the metallic layer to form a seal of the evaluable gap.

In some aspects, the metal deposition process includes friction surfacing.

Other features and aspects of the invention will become apparent in view of the following description and drawings.

### BRIEF DESCRIPTION OF THE DRAWINGS

FIG. 1 is a section view of an exemplary product including a substrate that defines an interior space, and a seal element that is coupled to the substrate and that isolates the interior space from a surrounding environment via a metal adhesive layer and a metal bridge element.

FIG. 2 is a top view of the substrate and the metal adhesive layer.

FIG. 3A is a partial tear-away view of another exemplary product including a first substrate, a second substrate, and a seal element formed of a metallic layer applied to each of the substrates and a bridge element attached to the metallic layers.

FIG. 3B is a partial section view of the product of FIG. 3A, illustrating the first and second substrates, the solid state weld, the seal element, and a secondary weld at a periphery of the first and second substrates.

FIG. 4 is a block diagram of an exemplary process for producing the seal element on one or more substrates that define an interior region configured to be isolated from the environment.

FIG. 5A is a schematic of a friction surfacing process for applying a malleable metal (e.g., aluminum) to a nonmetal (e.g., glass) to define a coating on the substrate that partially forms the seal element.

FIG. 5B is a schematic of a friction surfacing process for applying a malleable metal (e.g., aluminum) to a nonmetal (e.g., glass) to define a coating on the substrate that partially forms the seal element, with the mechatrode angled relative to the substrate.

FIG. 6 is a schematic of a solid-state process for welding a metal bridge element to the coating of FIG. 5 to form the seal element.

FIG. 7A is a microscopic view of a perforation-free coating formed using friction surfacing.

FIG. 7B is a microscopic view of the perforation-free coating of FIG. 7A with a metal foil welded to the coating that defines a seal element.

FIG. 8 is a schematic of the bond between a metallic layer and a substrate, and a metal oxide layer that forms on the metallic layer.

FIG. 9 is a block diagram of an exemplary process for applying a metallic layer or coating onto one or more substrates that can be incorporated into an end product.

FIG. 10 is a partial section view of the edge of an exemplary evacuated glazing assembly including an interior space and a metallic bridge element that isolates the interior space from a surrounding environment.

FIG. 11 is a partial section view illustrating a cross-section of a rotary sonotrode for creating a cold weld between each edge of the metallic bridge element of FIG. 1 and its respective substrate.

FIG. 12 is a partial section view illustrating a cross-section of a rotary sonotrode for creating a cold weld between each edge of the metallic bridge element of FIG. 11 and its respective substrate in a manner that the cold weld contains at least two highly-hermetic seal elements.

FIG. 13 is a partial section view illustrating an alternate cross-section of a rotary sonotrode for creating a cold weld between each edge of the metallic bridge element of FIG. 1 and its respective substrate in a manner that the cold weld contains at least two highly-hermetic seal elements.

Before any embodiments of the invention are explained in detail, it is to be understood that the invention is not limited in its application to the details of construction and the arrangement of components set forth in the following description or illustrated in the above-described drawings. The invention is capable of other embodiments and of being practiced or of being carried out in various ways without significantly departing from the spirit of the invention.

### DEFINITIONS

Terms of approximation, such as “about”, “generally”, “approximately”, or “substantially,” include values within ten percent greater or less than the stated value. When used in the context of an angle or direction, such terms include within ten degrees greater or less than the stated angle or direction. For example, “generally vertical” includes directions within ten degrees of vertical in any direction (e.g., clockwise or counter-clockwise).

As used herein, the terms “insulated glazing unit” and “glass panel assembly” are synonymous and denote a window glazing assembly formed from one or more glass members or glass elements (referred to as glass panes for purposes of description) that are at least partially transparent to electromagnetic radiation, that are substantially parallel along their planar faces, and that are substantially congruent shapes with surrounding edges sealed to form an interior space between the glass panes. These terms also encompass flat panel assemblies that have at least one element including glass and another element that can include glass, ceramic, aluminum, stainless steel, or other material. The interior space can be at least partially filled with a gas that is less conductive and, in some constructions, more viscous than air, or evacuated (e.g., by drawing a vacuum).

The term “pane” refers to a glass element intended for use as a wall element or substrate in a flat hermetically-sealed enclosure assembly.

“Differential pane movement” refers to the relative pane movement between two adjacent panes that occurs when the temperature of one pane changes relative to the temperature of the other pane. It may also refer to the relative pane movement that occurs under mechanical influence or other influence (e.g., impact during handling or use).

“Hermeticity” or “level of hermeticity” refers to a measure of the maximum leakage rate of which a seal is capable, measured for example in terms of standard cubic centimeters of helium/second per centimeter of seal length (“sccs/cm”), or equivalent. In general, higher hermeticity corresponds to a lower value of leakage rate, and vice versa.

“Hermetic” refers to a seal that is capable of achieving the hermeticity appropriate or specified for the application. It should be recognized that different areas within a cold weld may vary in level of hermeticity, and that an area within a cold weld may be described as hermetic without inferring that the hermeticity for that area is the same as for other areas within the same cold weld.

The term “highly-malleable” refers to an object or material having a yield stress no greater than 10,000 psi (e.g., no greater than 5,500 psi).

The phrase “solid-state” with respect to welding or coating means a joining process that does not involve melting of the materials being joined.

The term “cold weld” refers to a solid-state process for joining two or more parts.

The term “sonotrode” refers to a vibrating tool that transmits translational motion to the assembly of substrates to be welded by an ultrasonic bonding device.

The term “inboard,” with respect to a location of a first feature relative to a second feature on an assembly having a generally planar shape, refers to a location of the first feature on the side of the second feature that is closer to the centroid of the generally planar shape.

The term “outboard,” with respect to a location of a first feature relative to a second feature on an assembly having a generally planar shape, refers to a location of the first feature on the side of the second feature that is farther from the centroid of the generally planar shape.

The term “bridge element” means an element that is bonded to one or more substrates to isolate the resulting interior space from the environment.

The term “nip” means the area of the sonotrode rim in contact with the metal foil of bridge element 4.

The term “faying surfaces” means rubbing surfaces of foil area in the nip against the corresponding area of the substrate where friction under pressure creates rapid heating leading to bonding at the interface between the faying surfaces.

The term “channeled” means a sonotrode shape wherein the parallel circumferential channels have been formed in the rim.

### DETAILED DESCRIPTION

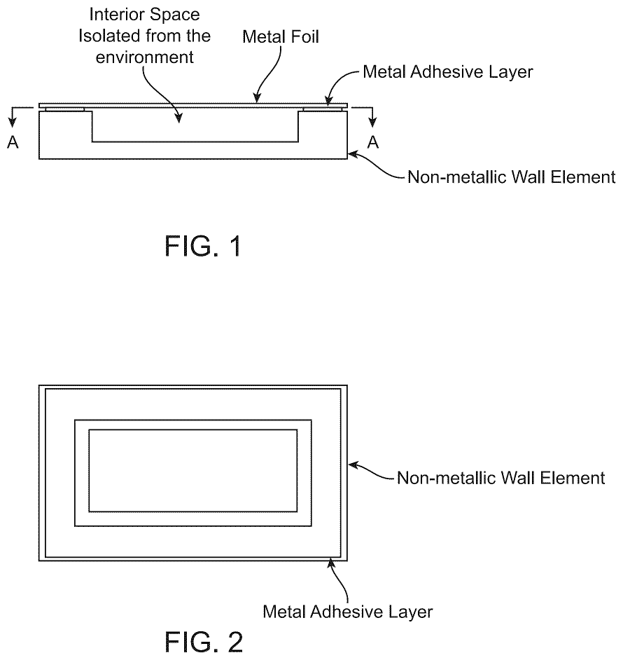

FIGS. 1 and 2 show an exemplary product (e.g., a MEMS package) that embodies the invention and that includes a wall element or substrate defining an interior space (also referred to as an evaluable gap or interior region) to be sealed and isolated from an environment surrounding the substrate. The substrate is non-metal (e.g., glass, such as a glass pane) and includes a base portion and edge portions that cooperatively define the interior space. A seal element is attached to the substrate to enclose the interior space and to seal the interior space from the surrounding environment. A schematic of an exemplary seal element is shown in FIG. 7B. As shown, the seal element is defined by a metal or metallic layer (referred to as a metallic layer for purposes of description and the claims) and a metal bridge element or foil (e.g., aluminum). The metallic layer defines a coating that is deposited or otherwise placed on the edge portions (e.g., around a periphery of the substrate consistent with FIG. 2). The bridge element is attached to the metallic layer (e.g., by a solid-state weld process) and extends over the interior space to effect a hermetic seal for the interior space. The bridge element can be formed of one or more layers of metal foil.

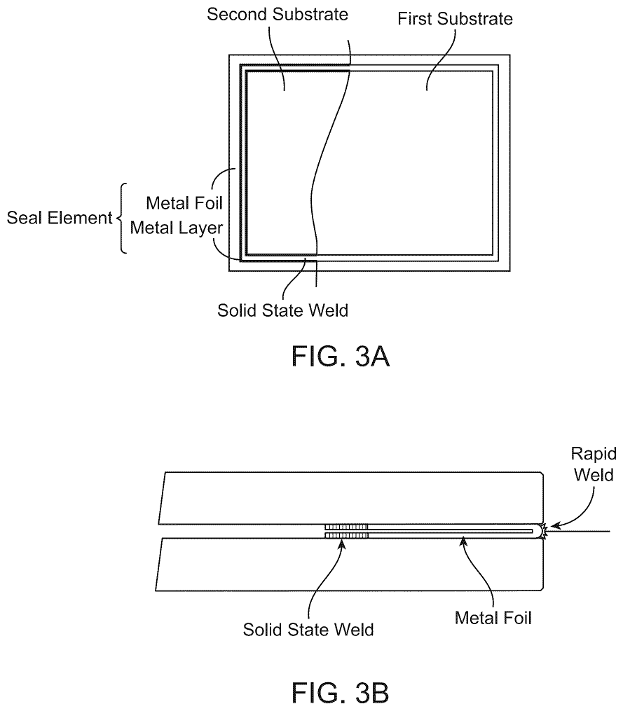

FIGS. 3A and 3B show another exemplary product (e.g., a window assembly) that embodies the invention. The product includes a first substrate (e.g., a glass pane or a glass sheet) and a second substrate (e.g., a glass pane or a glass sheet) that is spaced from the first substrate to define an interior space (i.e. an evaluable gap). The first and second substrates can be spaced in different ways, including by spacers that are formed from an incompressible or substantially incompressible material (e.g., composite, plastic, glass, metal, etc.). A seal element is attached to the substrate to enclose the interior space and to seal the interior space from the surrounding environment. As shown, the seal element is attached to respective lateral surfaces of the substrates (i.e. the surfaces that face each other). In some constructions, the seal element can be attached to the lateral surfaces that face away from each other, to the respective edges of the substrates, or a combination thereof.

With continued reference to FIGS. 3A and 3B, the seal element is defined by a metallic layer that is deposited or positioned on each of the first substrate and the second substrate, and a metal bridge element or foil (e.g., aluminum) that is attached to and extends between the metallic layers. The metallic layer on each substrate is deposited or applied to the substrate in a manner that defines a border for the interior space to be evacuated. In the illustrated example, the metallic layer is applied continuously around a perimeter of the interior space. The bridge element is attached to the metallic layer (e.g., by a solid-state weld process) across lateral portions of the interior space (i.e. between the substrates), and the metallic layers to hermetically seal the interior space. The solid-state weld defines the bond between the bridge element and the metallic layer and cooperates with the seal element to seal the interior space. In some constructions, getter material can be disposed in a space or gap between portions of the bridge element.

A second weld (e.g., rapid weld such as laser weld, MicroTIG weld, resistance weld, cold metal transfer, solder reflow, ultrasonic solder, etc.) can be applied to the outer extents of the bridge element and the respective substrates to further effect a hermetic seal for the interior space. The second weld defines the bond of the bridge element to each of the first substrate and the second substrate. That is, one portion of the bridge element is bonded to the first substrate by the second weld, and another portion of the bridge element is bonded to the second substrate by the second weld). In some constructions, the second weld can be performed in a vacuum chamber to eliminate the need for an evacuation port extending through one of the substrates.

While FIGS. 1-3B illustrate two exemplary products including the seal element, it will be appreciated that other products can include the seal element (e.g., flat panel displays, instrumentation, etc.).

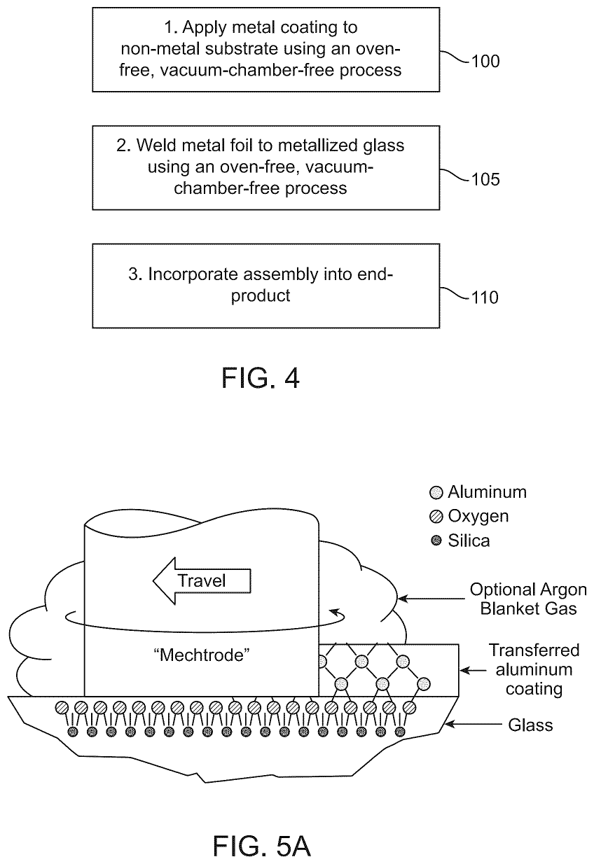

FIG. 4 illustrates an exemplary process with three primary steps for producing the seal element (a hermetic or non-hermetic seal element) and for placing and attaching the seal element relative to the substrate(s). It will be appreciated that FIG. 4 encompasses the general process and that additional steps may be incorporated into the process to facilitate formation of the seal element, as well as placement and attachment of the seal element on the substrate(s). The general process includes i) metallization of the non-metallic substrate, ii) bonding the metallic bridge element to the metallized substrate, and iii) incorporating the assembly into a product.

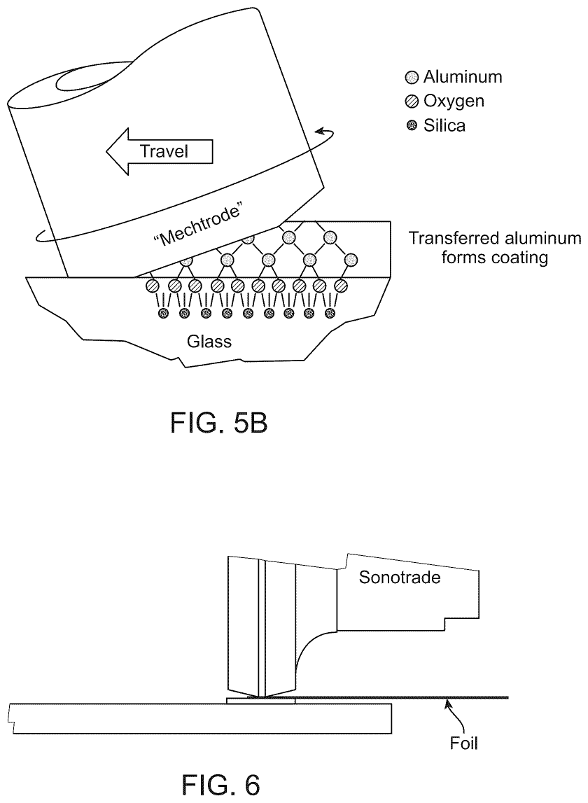

In the first primary step (step 100), the metallic layer (e.g., aluminum) is applied to the non-metallic substrate using a process or method that does not include an oven for heating the substrate, and that does not use a vacuum chamber (i.e. an oven-free, vacuum chamber-free process). FIGS. 5A, 5B show exemplary methods that use friction surfacing for metallizing the non-metallic substrate. Using friction surfacing, and with reference to FIGS. 7A and 7B, a malleable metal (e.g., aluminum) is applied to the non-metal substrate. Friction surfacing includes pressing a metal consumable (e.g., a “mechatrode”, which is formed of a malleable metal) onto the surface of the non-metallic substrate, and moving one or both of the metal consumable and the substrate (i.e. to achieve relative movement) to deposit or transfer the malleable metal onto the surface. This step, illustrated in FIG. 7A, forms the metallic layer on the non-metallic substrate. As shown in FIG. 5A, the metal consumable is generally flat (i.e. not angled) relative to the substrate during transfer of metal onto the substrate. As shown in FIG. 5B, the metal consumable is angled relative to the substrate during transfer of metal onto the substrate. In some constructions, a stable gas (e.g., argon) can be used to exclude oxygen during the friction surfacing process. The metallic layer defines an adhesive layer that is attached to the substrate and to which the metal bridge element can be attached. As shown in FIG. 2, the metallic layer extends continuously along or around a perimeter of the interior space.

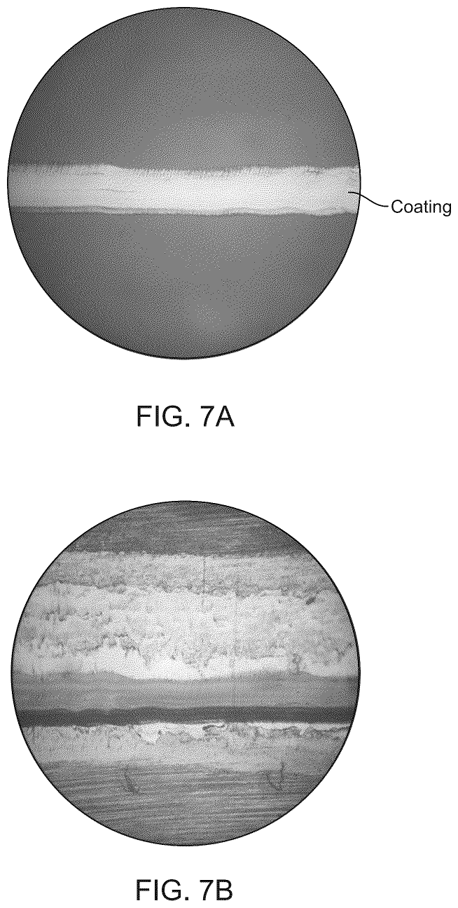

In the second primary step (step 105), and with reference to FIG. 7B, the metal bridge element is attached to the metallic layer. FIG. 6 illustrates one exemplary process that involves cold welding the metal bridge element to the metallic layer. A sonotrode of an ultrasonic seam welder can be used to weld the metal bridge element to the metallic layer. Ultrasonic welding and other cold welding processes are well known and, as such, it will not be described in detail.

Referring back to FIG. 4, the third primary step (step 110) includes further processing of the substrate-seal element assembly to produce a product such as a vacuum-insulated glass assembly (e.g., a window assembly or a flat panel display) with the interior space subjected to vacuum. The further processing of the assembly can take many forms, including igniting getter in the interior space and, in some cases, secondary welding or sealing steps that may be needed to ensure the interior space can be evacuated. It will appreciated that secondary steps may be included in or after each of the primary steps described above, and that further primary steps may be used to complete the VIG.

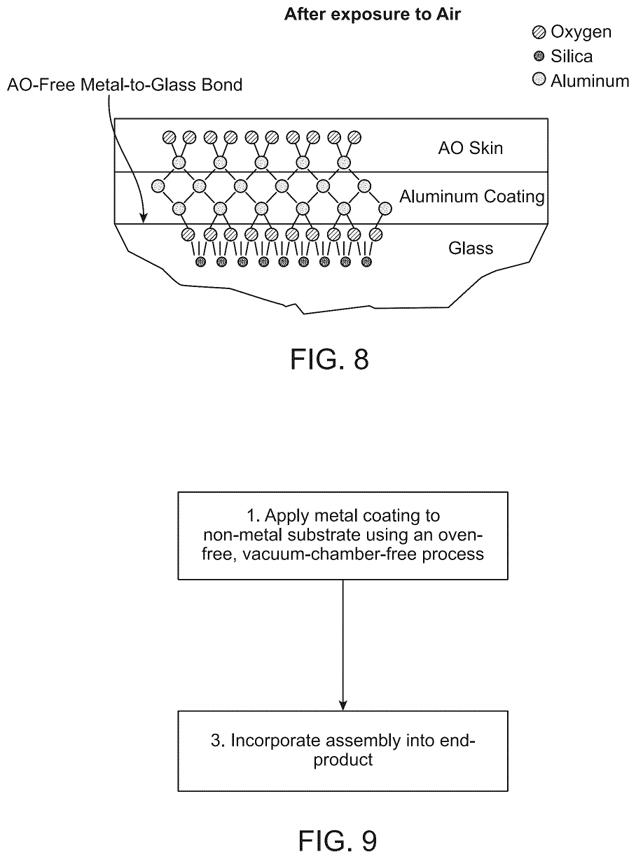

While FIGS. 5A-7A and 8 are described above relative to formation of the seal element, it will be appreciated that these figures also illustrate how friction surfacing can be used more generally to apply or form or affix a metallic layer on a non-metallic substrate with or without regard to formation of a seal element. For example, the process of attaching a metallic layer to a non-metallic substrate, as described and illustrated herein, can be applied in three-dimensional (“3D”) printing processes to form a metal layer or coating on a substrate that has a layer of metal oxide (e.g., aluminum adhered to a substrate with an aluminum oxide layer). The process also can be used to fabricate one or more metallic layers or traces on substrates that are used for vehicle windows (e.g., for defrost purposes; see FIG. 9), or to manufacture solar panels where the seal between portions of the solar panel need not be hermetic. The process of applying a metallic layer or coating to a non-metallic substrate as described herein can be used in other applications as well.

### EXAMPLES

Example 1: Two square panes of untempered window glass 10 inch by 10 inch are cut and cleaned by conventional means. A metallic layer forming a coating of 1100 series aluminum is applied to the lateral surface adjacent all four edges of each pane in the form of a ribbon, approximately 3 mm wide using friction surfacing. The process parameters are chosen to minimize the entrapment of aluminum oxide between the unoxidized aluminum and the glass, and to eliminate tearing of or other damage to the glass surface, such that the interface between the metal coating and the glass is highly-hermetic, and continuous along the perimeter of the region to be later evacuated. Then, each pane is completely covered with a layer of 1100 series aluminum foil, 75 microns thick, and the edges are ultrasonically-welded to the metallic layer. The area of each piece of foil inboard of the weld path is cut away to form a viewable area in the manner of a window. The foiled panes are placed together such the edges are aligned with the foil bridge elements touching each other. The edges of the foil bridge elements are cut flush with the edges of the pane assembly, and the foil elements are welded together using a laser to form a hermetic bridge element connecting the ribbons of metal adhesive coatings on their respective panes. The welded assembly is then evacuated though a small port through one pane. The port is subsequently sealed. The assembly can then be used as a vacuum insulating glass unit of square shape of 10 inches×10 inches.

It is understood that the invention may embody other specific forms, or incorporate combinations of the embodiments described herein, without departing from the spirit or characteristics the invention. While specific embodiments have been illustrated and described, other modifications may be made without significantly departing from the spirit of the invention.

Example 2: A MEMS device can be designed to communicate data to using light. To allow optical communication, the device is hermetically sealed in a small rectangular glass container (e.g., 25 mm×15 mm×5 mm having an open cavity with walls 3 mm thick, analogous to the arrangement shown in FIG. 1). The container is cleaned by conventional means. A coating of 6061 series aluminum is applied to the wall tops adjacent the cavity opening in the form of a continuous ribbon (e.g., approximately 3 mm wide and 1 micron thick) using friction surfacing. A laser and an infrared thermometer in a closed loop control system are used to maintain a consumable mechatrode (e.g., formed 6061 aluminum-the same material as the coating) at 200° C. to slightly reduce the yield strength of the 6061 aluminum forming the mechatrode. This reduces the risk of tearing the glass surface of the wall top.

The mechatrode is inclined from the vertical by 45 degrees in the vertical plane containing the ribbon centerline, with suitable automation to maintain both the linear speed and the rotational speed of the mechatrode constant or substantially constant, and to provide for turning the leaning mandrel to lead the ribbon around corners. The linear speed of the contact point between the mechatrode and the glass is maintained at 150 mm per minute. The rotational speed setpoint of the mechatrode is chosen to effect a relative speed of approximately 100,000 mm per second between the mechatrode surface at its contact point with the glass. The normal force on the mandrel is maintained at approximately 1 kgf. The path of the automated motion is closed such that the end of the ribbon overlaps its beginning to form a coating that is uninterrupted around cavity perimeter. Through a vacuum oven serving as a load lock, the container is placed into a glovebox filled with helium maintained at a dry condition, with dew point no greater than −60° C. Using gloves of suitable flexible and impermeable material, an operator inserts a MEMS device into the cavity of a metallized glass container, and the cavity opening is covered by a small coupon of 1100-12 H aluminum foil 150 microns thick. Using suitably-designed electrodes to maintain contact with the coating layer on glass to allow resistance welding, a hermetic seal is effected between the aluminum foil and the conductive aluminum coating on glass, which traps the dry helium inside the cavity and excludes air and moisture from the environment.

Example 3: Two panes of tempered window glass (e.g., sized approximately 2 m by 3 m) are cut and cleaned by conventional means. One of the panes has a low-emissivity coating and is edge-deleted (i.e. the portion of the low-emissivity coating along the path to be sealed is removed) using a method that does not mechanically damage the surface of the glass pane. A metallic layer forming a coating of 1100 series aluminum is applied to the lateral surface adjacent all four edges of each pane in the form of a ribbon (e.g., approximately 2 mm wide and 1 micron thick) using friction surfacing. During the coating process, a stream of industrial-grade argon is used to blanket the region in the environment surrounding the point of contact between the mechatrode and the glass panes to prevent further formation of aluminum oxide on the faying surfaces. The argon is slightly heated to 50° C. to avoid cooling the faying surfaces.

The mechatrode is inclined from the vertical by 30 degrees in the vertical plane containing the ribbon centerline, with suitable automation to maintain both the linear speed and the rotational speed of the mechatrode constant, and to provide for turning the leaning mandrel to lead the ribbon around corners. The linear speed of the contact point between the mechatrode and the glass pane is maintained at 300 mm per minute. The rotational speed setpoint of the mechatrode is chosen to effect a relative speed of approximately 200,000 mm per second of the mechatrode surface at its contact point with the glass. The normal force on the mandrel is maintained at approximately 0.5 kgf. The path of the automated motion is closed such that the end of the ribbon overlaps the beginning of the ribbon to form a coating with a bond that is highly-hermetic between metal and glass and uninterrupted around the cavity perimeter.

Each pane is completely covered with a layer of 1100 series aluminum foil (e.g., 75 microns thick), and the edges of the foil are laser-welded to the metallic layer using an argon blanket such that the bond between the foil and metal coating on glass is highly-hermetic and continuous along the perimeter of the region to be evacuated. The area of each piece of foil inboard of the weld path is cut away to form a viewable area (e.g., a window), forming foil bridge elements. The foiled panes are placed together such the edges are aligned with the foil bridge elements touching each other. The edges of the foil bridge elements are cut flush with the edges of the pane assembly. All but a 300 mm-long section of the perimeter edges of the foil elements are welded together using a tungsten-inert gas (TIG) process with an argon blanket to form a highly-hermetic bridge element that connects to the ribbons of metal (also referred to as adhesive coatings) on the respective panes. Using a suitable evacuation fixture with a transparent window to make a seal surrounding the unwelded 300 mm-long section, the partially-welded assembly is evacuated though gap between the two foil layers along the unwelded section. A laser traveling through the window of the evacuation fixture is used to weld the unwelded section to complete the highly-hermetic perimeter weld. The rectangular assembly can then be used as a vacuum insulating glass unit.

Example 4: A strip of glass, 50 mm×1000 mm×3 mm thick, is cut and cleaned by conventional means. A coating of 1100 series aluminum is applied to the lateral surface in the form of a metallic ribbon, approximately 2 microns thick, 3 mm wide, and 990 mm long, using friction surfacing. During the coating process, a stream of argon (e.g., industrial-grade argon) is used to blanket the region surrounding the point of contact between the mechatrode and the glass to prevent formation of aluminum oxide on the faying surfaces. The argon is slightly cooled to 10° C. to remove heat generated at the faying surfaces. The mechatrode is inclined from the vertical by 70 degrees in the vertical plane (orthogonal to the ribbon centerline), with suitable automation to maintain constant both the linear speed and the rotational speed of the mechatrode. The linear speed of the contact point between the mechatrode and the glass is maintained at 100 mm per minute. The rotational speed setpoint of the mechatrode is chosen to effect a relative speed of approximately 100,000 mm per second of the mechatrode surface at its contact point with the glass. The normal force on the mandrel is maintained at approximately 1 kgf. The path of the automated motion is a straight line in this example. Next, a ribbon of 1100 series aluminum foil (e.g., 125 microns thick and 6 mm wide) is ultrasonically seam-welded to the metallic coating previously applied to the glass strip such that the longitudinal centerline of the aluminum foil ribbon is approximately aligned with the longitudinal centerline of the metallic ribbon. The bond between the foil and metallic coating that is formed is mechanically strong, and the bond properties can be hermetic or non-hermetic. The glass strip in this example can be incorporated into a solar panel collector such that the aluminum foil ribbon serves as a common buss bar to collect electrical current from individual solar cells on the panel.

Several examples are described and illustrated with regard to forming or applying a metallic layer or coating on substrates formed of or including glass (e.g., to facilitate formation of a seal element, or to facilitate connection between a metal bridge element and a glass substrate with or without regard to forming a seal element). It will be appreciated that the invention described herein is equally applicable to forming a metallic layer or coating on other non-metal substrates, and shall not be limited to glass substrates.

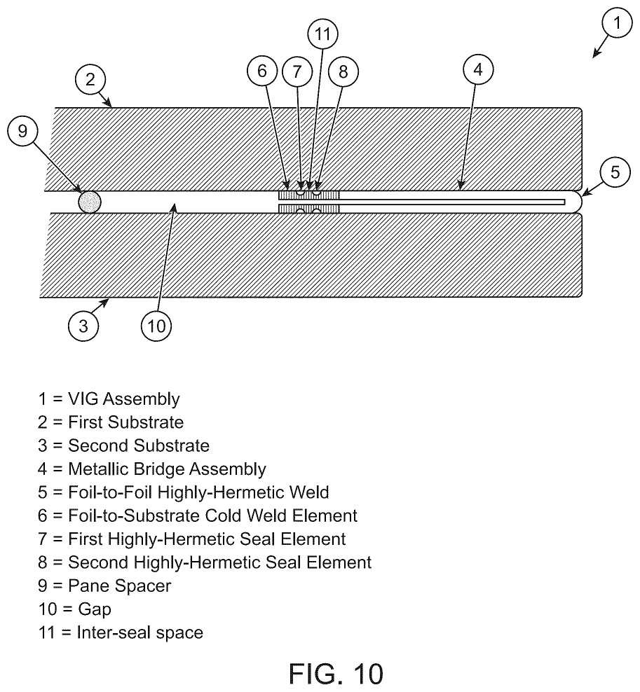

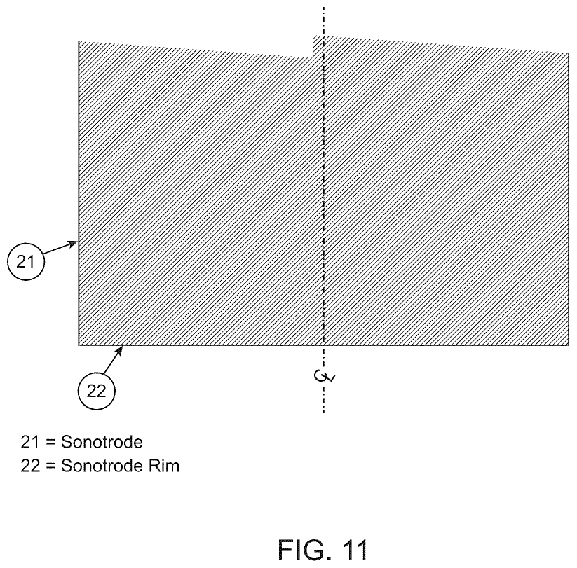

FIG. 10 illustrates a portion of an exemplary evacuated glazing assembly 1 (e.g., a window assembly configured for installation into an exterior wall of a building) that includes a first substrate 2 (e.g., a first pane) and a second substrate 3 (e.g., a second pane) spaced from the first substrate 2 to define an interior space 10 (also referred to as an evaluable gap or interior region) to be sealed and isolated from an environment surrounding the evacuated glazing assembly 1. One or more pane spacers 9 formed from an incompressible or substantially incompressible material (e.g., composite, plastic, glass, metal, etc.) may be positioned in the interior space 10 between the substrates 2, 3 to maintain a consistent gap width between the substrates 2, 3. The substrates 2, 3 in the illustrated embodiment are non-metal (e.g., glass, such as annealed or tempered glass). In other embodiments, one or both substrates 2, 3 may be metallic. A metallic bridge element 4 is attached to each of the substrates 2, 3 to seal the interior space 10 from the surrounding environment.

With continued reference to FIG. 10, the metallic bridge element 4 can be formed of one or more layers of metal foil (e.g., aluminum foil). For convenience and reduced cost, the bridge element 4 may be formed from two parts, each cold welded to its respective substrate, and later combined into a single bridge element 4 by forming a hermetic foil-to-foil connecting weld 5 (e.g., a fusion weld, such as a laser weld, MicroTIG weld, resistance weld, etc., or the weld 5 may include a solid-state weld). In other embodiments, the bridge element 30 may be integrally formed from a single piece of material.

Referring to FIG. 10, the bridge element 4 is attached to each of the substrates 2, 3 by a cold weld 6. Each cold weld 6 has a first seal element 7 (e.g., a weld) and a second seal element 8 (e.g., a weld) extending parallel to the first seal element 7. The bridge element 4 extends across the interior space 10 along its perimeter boundary (i.e. between the substrates 2, 3) to hermetically seal the interior space 10. The cold weld 6 provides a structural connection between the bridge element 4 and the substrates 2, 3. That is, the cold weld 6 is configured to survive the forces and stresses due to thermal expansion or differential pane movement. In some embodiments, the structural connection between the bridge element 4 and the substrates 2, 3 defined by the cold welds 6 has a greater shear strength than the tensile strength of the bridge element 4 itself.

FIG. 11 illustrates a rotary sonotrode 21 including a rim 22 that has a smooth circumferential contour (e.g., a cylindrical contour). The sonotrode 21 may be used to make multiple, consecutive passes on the bridge element 4 to form the seal elements 7, 8 (e.g., consecutive, parallel welds or seal elements), which are shown in in FIG. 10. Some embodiments of a sonotrode incorporate a textured rim (e.g., waffling or roughness) to reduce slipping in the nip between the sonotrode and the metal foil to promote maximum slipping between the faying surfaces.

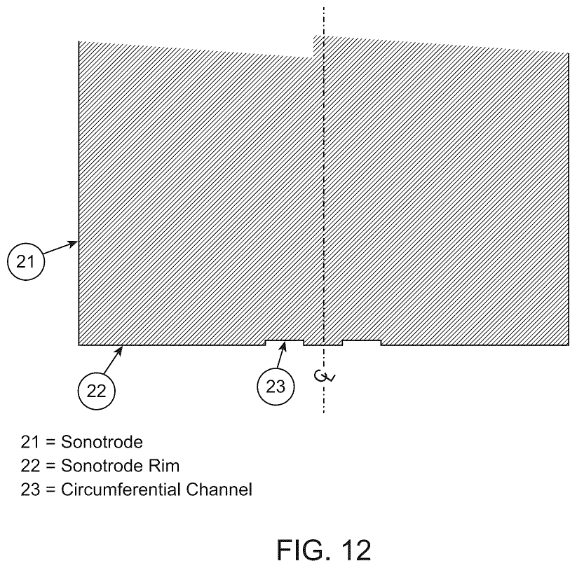

FIG. 12 illustrates another rotary sonotrode 21 including a rim 22 that has channels 23 configured to form the seal elements 7, 8 (e.g., concurrent, parallel welds or seal elements), shown in FIG. 10, in a single pass of the rotary sonotrode 21. As shown, the sonotrode 21 has two channels 23 that extend circumferentially around the rim 22 and that are parallel to each other. The channels 23 may be formed by machining the rim 22 or other suitable processes (e.g., molding, etc.). The sonotrode 21 does not include a waffle texture. That is, there are not any channels that extend perpendicular or at an acute angle to the parallel circumferential channels. The profile of FIG. 12 facilitates making concurrent, parallel seal elements 7, 8 via the channels 23.

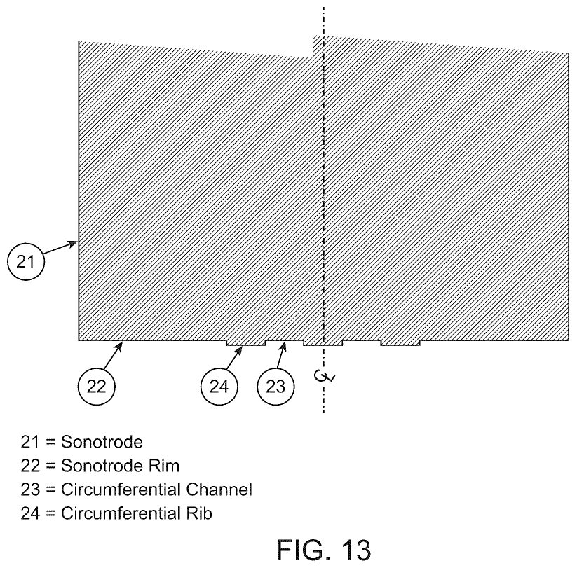

FIG. 13 illustrates another rotary sonotrode 21 including a rim 22 that has at least three ribs 24 and channels 23 that are disposed between the ribs 24. The ribs 24 are parallel to each other and extend circumferentially around the sonotrode 21, and the channels 23 likewise extend circumferentially around the rim 22 and are parallel to each other. The rotary sonotrode 21 in FIG. 13 is configured to form the seal elements 7, 8 (e.g., concurrent, parallel welds or seal elements), shown in FIG. 10, in a single pass of the rotary sonotrode 21. The ribs 24 may be machined into the rim 22 or formed by other suitable processes (e.g., molding, etc.). The sonotrode 21 does not include a waffle texture. That is, there are not any channels that extend perpendicular or at an acute angle to the parallel circumferential channels. The profile of FIG. 13 facilitates making concurrent, parallel seal elements 7, 8 via the channels 23.

The metallic bridge element may provide hermetically sealing between two substrates of an evacuated glazing assembly. The hermetic seal may be formed by bonding the metallic bridge element to each of the two substrates to form at least two hermetic sealing stages. A sealing material can be applied at least partially in contact with a first hermetic sealing stage of the two hermetic sealing stages, and the sealing material may be cured (e.g., heated) to form a second hermetic sealing stage. Bonding the metallic bridge element to each of the two substrates may be accomplished by cold welding. In one example, the metallic bridge element is formed of a material including at least one material selected from a group consisting of aluminum, titanium and copper.

It will be appreciated that two or more seal elements may be formed by an exemplary sonotrode, and the formation of the seal elements may be consecutive, concurrent, or a combination thereof. For example, more than two seal elements 7, 8 may be formed within the foil-to-substrate cold weld 6 by virtue of increasing the quantity of circumferential channels 23 in the profile of the rotary sonotrode rim 22. For example, a sonotrode 21 with a rim 22 that has three channels 23 (e.g., formed by four adjacent ribs 24, or defined in the surface of the sonotrode rim 22) may be used to form three concurrent, parallel seal elements 7, 8 via the channels 23 (i.e. a three-part seal element or a triple, concurrently formed seal element).

Forming at least two spaced-apart seal elements 7, 8 according to embodiments and sonotrode shape features described and illustrated herein provides numerous advantages over the use of a single seal element. For example, the second seal element 8 provides a redundant hermetic seal relative to the first seal element 7 that may maintain the integrity of the cold weld 6 should the hermeticity of first seal element 7 be compromised by any of a variety of different mechanisms, including non-perforation flaws in the metallic bridge element 4 (e.g., scratches, wrinkles, etc.), or flaws in the substrate(s) 2, 3 (e.g., scratches). In some embodiments, the two spaced-apart seal elements 7, 8 may also provide the VIG with a longer useful life. However, if a single flaw (e.g., glass scratch) extends across both seal elements 7, 8, a path for inflow of gas molecules may exist and the VIG life may be reduced.

A significant advantage of the foil-to-substrate cold weld 6 according to embodiments described and illustrated herein is that the metal bridge element 4 is in strong mechanically-bonded contact with the non-metal substrate. While portions of cold weld 6 are highly hermetic (i.e. seal elements 7, 8), the remaining portion of element 6, albeit of lower hermeticity, nonetheless provides a great deal of additional mechanical strength, thereby providing partial mechanical isolation of the highly-hermetic seal elements 7, 8 from stresses arising from sources external to element 6 (e.g., differential pane movement, thermal gradients).

Because the seal elements 7, 8 are spaced apart, residual gas molecules may become trapped therebetween in the microscopic pockets of the inter-seal space 11. Nevertheless, said molecules are relatively few in number (due to the negligible trapped volume), and the lower-hermeticity portions of cold weld 6 provide a highly tortuous path for those molecules that may migrate into the gap 10 from the inter-seal space 11. Our research indicates that VIG performance can survive a full-length cyclic temperature test similar to or even more rapid than that described in accelerated life testing standard “ASTM E2188-19 Standard Test Method for Insulating Glass Performance.”

In embodiments of the invention, the foil-to-substrate cold weld 6 is formed by a rotary seam ultrasonic welder. In some embodiments, a bar-type ultrasonic welder may be used.

While FIG. 1 illustrates an exemplary product including this invention, it will be appreciated that other products can benefit (e.g., flat panel displays, neutron detectors, solar panels). As such, the invention described and claimed herein should not be construed to encompass only window assemblies.

It is understood that the invention may embody other specific forms, or incorporate combinations of the embodiments described herein, without departing from the spirit or characteristics the invention. While specific embodiments have been illustrated and described, other modifications may be made without significantly departing from the spirit of the invention.

Although the invention has been described in detail with reference to certain preferred embodiments, variations and modifications exist within the scope and spirit of one or more independent aspects of the invention as described. It will be appreciated that each feature of the invention may form the basis of one or more claims on its own or in any combination with any other feature or features. The order in which the invention has been described in no way informs the features, alone or in combination, which may be novel and inventive. That is, the order that the invention has been described is only for convenience and should not be construed as limiting regarding what may be claimed.

Various aspects and preferred embodiments of the present invention are now presented with reference to the following clauses.

Clause 1. An evacuated glazing assembly having first and second spaced-apart substrates connected to each other by a seal element to form an evaluable interior space therebetween. The seal element may be formed by bonding a metallic bridge element to at least one of the substrates with a cold weld.

Clause 2. In some embodiments, the cold weld includes at least two spaced-apart, highly-hermetic seal elements fabricated simultaneously during bonding on the at least one of the substrates.

Clause 3. In some embodiments, each seal element is formed by ultrasonic welding.

Clause 4. In some embodiments, the forming of each of the two seal elements is accomplished by rotary ultrasonic welding.

Clause 5. In some embodiments, the cold weld includes contacting the metallic bridge element with a vibrating sonotrode.

Clause 6. In some embodiments, the forming of the seal element is accomplished by using a rotary sonotrode having parallel ribs on a rim of the rotary sonotrode.

Clause 7. In some embodiments, the glass has been coated with a thin metallic layer prior to bonding of the metallic bridge element.

Clause 8. In some embodiments, the seal element is formed by bonding a metallic bridge element to each of the substrates with respective cold welds forming parallel seal elements on each of the substrates.

Clause 9. In some embodiments, an evacuated glazing assembly includes a first substrate, a second substrate spaced from the first substrate to define an interior space therebetween, and a metallic bridge element disposed between the first substrate and the second substrate to hermetically isolate the interior space from a surrounding environment

Clause 10. In some embodiments, the bridge element includes a first seal element formed by a cold-welded bond between the metallic bridge element and the first substrate, and a second seal element spaced apart from the first seal element and formed by a cold-welded bond between the metallic bridge element and the first substrate.

Clause 11. In some embodiments, the first and second seal elements are formed simultaneously.

Clause 12. In some embodiments, each of the first seal element and the second seal element defines a structural connection between the metallic bridge element and the first substrate having a shear strength greater than a yield strength of the metallic bridge element.

Clause 13. In some embodiments, both the first seal element and the second seal element partially define a hermeticity of the evacuated assembly.

Clause 14. A method of forming a metallic bridge element for hermetically sealing between two substrates of an evacuated glazing assembly. The method includes bonding a metallic bridge element to each of the two substrates to form at least two hermetic sealing stages, applying a sealing material at least partially in contact with a first hermetic sealing stage of the hermetic sealing stages, curing the sealing material to form a second hermetic sealing stage of the hermetic sealing stages.

Clause 15. In some embodiments, bonding the metallic bridge element to each of the two substrates is accomplished by cold welding.

Clause 16. In some embodiments, the metallic bridge element material includes at least one selected from a group consisting of aluminum, titanium and copper.

Clause 17. A structural element for buildings having at least two spaced-apart non-metal substrates connected to each other by a seal element to form an evaluable gap therebetween. The seal element is formed by subjecting at least one surface of each of the non-metal substrates to an oven-free, vacuum chamber-free metal deposition process to form a metallic layer on each of the substrates.

Clause 18. The metallic layer on each of the non-metal substrates may define coatings that are continuous along a perimeter of the evaluable gap.

Clause 19. In some embodiments, the seal element is further formed by connecting a metal bridge element to the metallic layer to form a seal of the evaluable gap.

Clause 20. In some embodiments, the metal deposition process includes friction surfacing.

Clause 21. In some embodiments, the bridge element is connected to the metallic layers via ultrasonic welding.

Clause 22. In some embodiments, the substrates include glass.

Clause 23. In some embodiments, the bridge element includes a metal foil and the seal is hermetic.

Clause 24. A method of manufacturing a structural element including first and second substrates of substantially congruent shapes. The method includes forming a seal element between the substrates to define an evaluable gap.

Clause 25. The seal element may be formed by the process of subjecting at least one surface of each substrate to an oven-free, vacuum chamber-free metal deposition process to form a metallic layer on the substrates, the metallic layers defining a coating that are continuous along the perimeter of the evaluable gap.

Clause 26. In some embodiments, the seal element is further formed by connecting a bridge element to the metallic layers to define a hermetic seal of the evaluable gap.

Clause 27. In some embodiments, the metal deposition process includes friction surfacing.

Clause 28. In some embodiments, the bridge element is connected to the metallic layers via ultrasonic welding.

Clause 29. In some embodiments, the bridge element includes a metal foil.

Clause 30. In some embodiments, wherein the substrates include glass.

Clause 31. An insulated glazing unit including a first flat panel element and a second flat panel element. The first and second flat panel elements have congruent shapes. The glazing unit also includes a plurality of spacers disposed between the first flat panel element and the second flat panel element to space the first flat panel element from the second flat panel element, and a seal element connecting the first flat panel element and the second flat panel element to form an evaluable gap therebetween.

Clause 32. In some embodiments, the seal element is formed by the process of subjecting at least one surface of each substrate to an oven-free, vacuum chamber-free metal deposition process to form a metallic layer on each of the substrates, the metallic layers defining coatings that are continuous along a perimeter of the evaluable gap, and connecting a bridge element to the metallic layers to form a hermetic seal of the evaluable gap.

Clause 33. A method of manufacturing a structural element including a substrate defining an interior space. The method includes forming a seal element to enclose the interior space and define an evaluable gap.

Clause 34. In some embodiments, the seal element may be formed by the process of subjecting a surface of the substrate to an oven-free, vacuum chamber-free metal deposition process to form a metallic layer on the substrate, the metallic layer defining a coating that is continuous along a perimeter of the interior space, and connecting a bridge element to the metallic layer and extending across the interior space to define a seal of the evaluable gap.

Clause 35. In some embodiments, the connecting step includes defining a hermetic seal.

Clause 36. A process for creating a seal element for incorporation into an envelope having an interior region isolated from an environment. The process includes subjecting the surface of a wall element to a metal deposition process that is oven-free and vacuum chamber-free to form a metallic layer extending continuously along the perimeter of the interior region to be isolated from the environment, and connecting a bridge element to the metallic layer to form a seal element along the perimeter of the interior region.

Clause 37. In some embodiments, the connecting step includes defining a hermetic seal.

Clause 38. A method of manufacturing a structural element. The method includes subjecting a surface of a non-metallic substrate to an oven-free, vacuum chamber-free metal deposition process including friction surfacing to form a metallic layer on the substrate, the metallic layer defining a coating on the substrate, and connecting a metal foil to the metallic layer.

Clause 39. A structural element including a non-metallic substrate including a metallic layer on at least a portion of the substrate and formed using a friction surfacing process, and a metal foil attached to the substrate via the metallic layer.

Clause 40. In some embodiments, the friction surfacing process includes subjecting at least one surface of the substrate to an oven-free, vacuum chamber-free metal deposition process.

Clause 41. A method of manufacturing a structural element. The method includes subjecting a surface of a non-metallic substrate to an oven-free, vacuum chamber-free metal deposition process including friction surfacing to form a metallic layer on at least a portion of the substrate.

Clause 42. In some embodiments, the metallic layer defines a coating on the substrate.

Clause 43. In some embodiments, the non-metallic substrate includes a vehicle window and the metallic layer is formed in a line that extends along a length or width of the vehicle window.

Although the invention has been described with reference to certain embodiments, variations and modifications exist within the scope and spirit of one or more independent aspects of the invention as described.

Various features of the invention are set forth in the following claims.

1. An evacuated glazing assembly having first and second spaced-apart substrates connected to each other by a seal element to form an evaluable interior space therebetween, wherein the seal element is formed by:
bonding a metallic bridge element to at least one of the substrates with a cold weld, the cold weld including at least two spaced-apart, highly-hermetic seal elements fabricated simultaneously during bonding along an edge of the at least one of the substrates.

2. The evacuated glazing assembly of claim 1, wherein each seal element is formed by ultrasonic welding.

3. The evacuated glazing assembly of claim 2, wherein the forming of each of the two seal elements is accomplished by rotary ultrasonic welding.

4. The evacuated glazing assembly of claim 1, wherein the cold weld includes contacting the metallic bridge element with a vibrating sonotrode.

5. The evacuated glazing assembly of claim 4, wherein the forming of the seal element is accomplished by using a rotary sonotrode having parallel ribs on a rim of the rotary sonotrode.

6. The evacuated glazing assembly of claim 1, wherein the at least one of the substrates has been coated with a thin metallic layer prior to bonding of the metallic bridge element.

7. The evacuated glazing assembly of claim 1, wherein the seal element is formed by bonding a metallic bridge element to each of the substrates with respective cold welds forming parallel seal elements on each of the substrates.

8. An evacuated glazing assembly comprising:
a first substrate;
a second substrate spaced from the first substrate to define an interior space therebetween;
a metallic bridge element disposed between the first substrate and the second substrate to hermetically isolate the interior space from a surrounding environment, wherein the bridge element includes:
a first seal element formed by a cold-welded bond between the metallic bridge element and the first substrate; and
a second seal element spaced apart from the first seal element and formed by a cold-welded bond between the metallic bridge element and the first substrate,
wherein the first and second seal elements are formed simultaneously along an edge of the first substrate.

9. The evacuated glazing assembly of claim 8, wherein each of the first seal element and the second seal element defines a structural connection between the metallic bridge element and the first substrate having a shear strength greater than a yield strength of the metallic bridge element.

10. The evacuated glazing assembly of claim 9, wherein both the first seal element and the second seal element partially define a hermeticity of the evacuated assembly.

11-18. (canceled)

19. A method of manufacturing a structural element including first and second substrates of substantially congruent shapes, the method comprising:
forming a seal element between the substrates to define an evaluable gap, the seal element formed by the process of:
subjecting at least one surface of each substrate to an oven-free, vacuum chamber-free metal deposition process to form a metallic layer on each of the substrates, the metallic layers defining a coating that are continuous along the perimeter of the evaluable gap; and
connecting a bridge element to the metallic layers to define a hermetic seal of the evaluable gap,
wherein the connection of the bridge element to each of the metallic layers includes at least two spaced-apart, highly-hermetic seal elements fabricated simultaneously.

20. The method of claim 19, wherein the metal deposition process includes friction surfacing.

21. The method of claim 19, wherein the bridge element is connected to the metallic layers via ultrasonic welding.

22. The method of claim 19, wherein the bridge element includes a metal foil.

23. The method of claim 19, wherein the substrates include glass.

24-29. (canceled)

30. The evacuated glazing assembly of claim 8, wherein each of the first substrate and the second substrate is non-metallic and one or both of the first substrate and the second substrate includes
a metallic layer disposed on at least a portion of the corresponding substrate and formed using a friction surfacing process, wherein the metallic bridge element includes a metal foil, and
wherein the friction surfacing process includes subjecting at least one surface of the corresponding substrate to an oven-free, vacuum chamber-free metal deposition process.

31. (canceled)

32. The evacuated glazing assembly of claim 8, wherein the first substrate and the second substrate define a vehicle window and the metallic layer is formed in a line that extends along a length or width of the vehicle window.

33. The evacuated glazing assembly of claim 8, wherein each of the first seal element and the second seal element includes an ultrasonic weld.

34. The evacuated glazing assembly of claim 8, wherein each of the first seal element and the second seal element is defined by contacting a rotary sonotrode to the metallic bridge element, and wherein the rotary sonotrode has parallel ribs on a rim of the rotary sonotrode.

35. The evacuated glazing assembly of claim 8, wherein the first substrate includes a coating of a thin metallic layer prior to bonding the metallic bridge element to the first substrate.
